(19) United States
(12) Patent Application Publication
(10) Pub. No.: US 2007/0060663 A1
(43) Pub. Date: Mar. 15, 2007

(54) Photocurable composition, photocurable ink composition, printing method and resist composition using the same

(75) Inventor: Satoshi Masumi, Kanagawa (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/388,419

(22) Filed: Mar. 24, 2006

(30) Foreign Application Priority Data
Sep. 15, 2005 (JP) JP2005-268359

(51) Int. Cl. C08G 59/68

(52) U.S. Cl. 522/31

(57) ABSTRACT

A photocurable composition comprising: (i) a cationically curable oligomer having a molecular weight of 800-200,000; and (ii) a sulfonium salt represented by Formula (1) which is described in the specification:

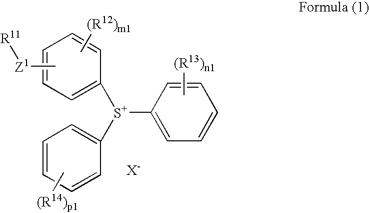

This application is based on Japanese Patent Application No. 2005-268359 filed on Sep. 15, 2005 in Japanese Patent Office, the entire content of which is hereby incorporated by reference.

### TECHNICAL FIELD

The present invention relates to a photocurable composition incorporating a sulfonium salt having a property of not releasing benzene which is hazardous to humans and resulting in excellent stability over an elapse of time. The present invention also relates to a photocurable ink composition, a printing method and a resist composition using the same.

### BACKGROUND

In recent years, a cationically photocurable compositions have received attention due to development of new monomers which exhibit no polymerization inhibition by oxygen and which exhibit minimal unpleasant odor, as well as low viscosity. Further, in the field of photoresists, attention is paid as effective chemical amplification type resist. For example, disclosed is no formation of benzene, as well as excellent ejectability and close adhesion of the cured materials (refer, for example, to Patent Document 1). However, when applied to uses other than ink-jet printing, it has been found that stability of an ink composition is unsatisfactory. Further, though Patent Document 2 describes photolytically acid generating agents for photoresists (refer, for example, to Patent Document 2), stability of the ink composition has also been found to be insufficient.

(Patent Document 1) Japanese Patent Publication for Public Inspection (hereinafter referred to as JP-A) No. 2005-97557 (claims and examples)

(Patent Document 2) JP-A No. 9-15848 (claims and examples)

### SUMMARY

In view of the foregoing, the present invention was achieved. An object of the present invention is to provide a photocurable composition incorporating a sulfonium salt which does not release benzene, which is hazardous to humans and which results in excellent stability over an elapse of time, and a resist composition.

It is possible to achieve the above object of the present invention employing the following embodiments.

(1) In a photocurable composition incorporating a cationically curable compound, the photocurable composition incorporates at least a cationically curable oligomer having a molecular weight of 800-200,000, and also incorporates the sulfonium salt compound represented by the following Formula (1).

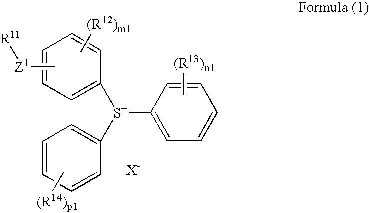

wherein R¹¹ and R¹² each represents an alkyl group or an aryl group; Z¹ represents an oxygen atom or a sulfur atom; R¹³ and R¹⁴ each represents an alkyl group, an aryl group, an alkoxy group, an aryloxy group, an alkylthio group, or an arylthio group; m1 represents an integer of 0-4; n1 and p1 each represents an integer of 1-5; X represents Z—SO₃ (Z represents CₙF₂ₙ₊₁ (in which n represents 1-10), an alkyl group, an unsubstituted aryl group or an alkyl substituted aryl group), BF₄, AsF₆, SbF₆, B(C₆F₅), ClO₄, Br, Cl, or I.

(2) The photocurable composition described in above Item (1) wherein the sulfonium salt compound represented by above Formula (1) is a compound represented by following Formula (2).

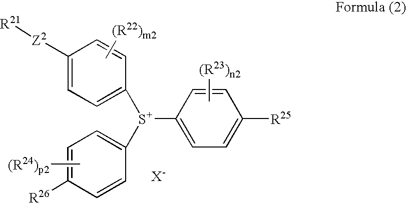

wherein R²¹, R²², R²³, and R²⁴ each represents an alkyl group or an aryl group; Z² represents an oxygen atom or a sulfur atom; R²⁵ and R²⁶ each represents an alkyl group, a fluorinated hydrocarbon group, an aryl group, an alkoxy group, an aryloxy group, an alkylthio group, or an arylthio group; m2, n2, and p2 each represents an integer of 0-4; and X is the same as defined for X in Formula (1).

(3) The photocurable composition described in above Item (2), wherein the sulfonium salt compound represented by above Formula (2) is a compound represented by following Formula (3).

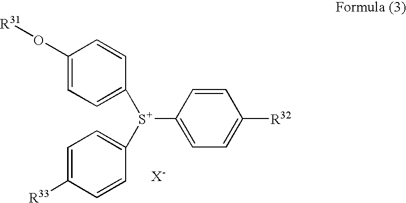

wherein R³¹ represents an alkyl group having 1-10 carbon atoms; R³² and R³³ each represents an alkyl group having 1-10 carbon atoms or an alkoxy group having 1-10 carbon atoms; and X is the same as defined for X in Formula (1).

(4) The photocurable composition described in above Item (2), wherein the sulfonium salt compound represented by above Formula (2) is a compound represented by following Formula (4).

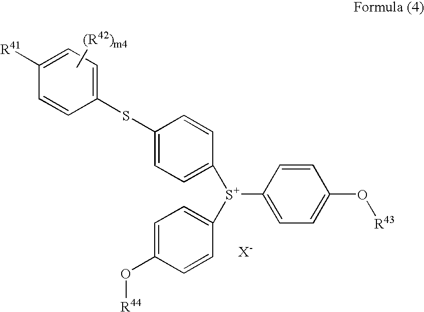

wherein R⁴¹ represents a hydrogen atom or an alkyl group having 1-10 carbon atoms; R⁴² represents a substituent; m4 represents an integer of 0-4; R⁴³ and R⁴⁴ each represents an alkyl-group having 1-10 carbon atoms, and X is the same as defined for X of Formula (1).

(5) The photocurable composition described in above Item (2), wherein the sulfonium salt compound represented by above Formula (2) is a compound represented by following Formula (5).

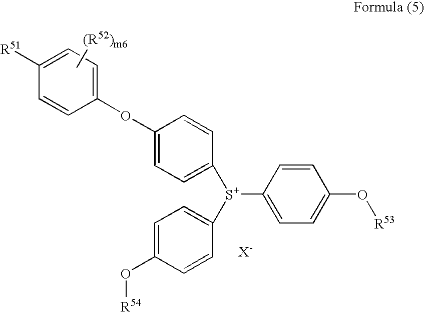

wherein R⁵¹ represents a hydrogen atom or an alkyl group having 1-10 carbon atoms; R⁵² represents a substituent; m5 represents an integer of 0-4; R⁵³ and R⁵⁴ each represents an alkyl group having 1-10 carbon atoms, and X is the same as defined for X of Formula (1).

(6) The photocurable composition described in any one of above Items (1)-(5), further incorporating at least one selected from the group consisting of epoxy compounds, oxetane compounds, and vinyl ether compounds.

(7) A photocurable ink composition incorporating the photocurable composition described in any one of above Items (1)-(6) and a pigment dispersion.

(8) A printing method employing the photocurable ink composition described in above Item (7).

(9) A resist composition incorporating an oligomer of a molecular weight of 800-200,000 having a protected group, the oligomer becoming alkali-soluble after being subjected to an acid process, as well as a sulfonium salt compound represented by following Formula (1).

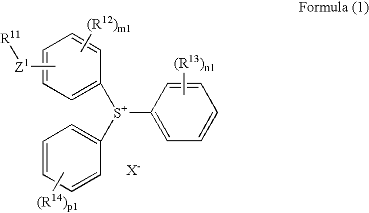

wherein R¹¹ and R¹² each represents an alkyl group or an aryl group; Z¹ represents an oxygen atom or a sulfur atom; R¹³ and R¹⁴ each represents an alkyl group, an aryl group, an alkoxy group, an aryloxy group, an alkylthio group, an arylthio group; m1 represents an integer of 0-4; n1 and p1 each represents an integer of 1-5; X represents Z-SO₃ (Z represents CₙF₂ₙ₊₁ (in which n represents 1-10), an alkyl group, an unsubstituted aryl group or an alkyl substituted aryl group), BF₄, AsF₆, SbF₆, B(C₆F₅), ClO₄, Br, Cl, or I.

(10) The resist composition described in above Item (9), wherein the sulfonium salt compound represented by Formula (1) incorporated in the resist composition described in above Item (9) is a compound represented by following Formula (2).

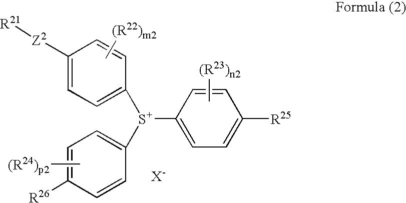

wherein R²¹, R²², R²³, and R²⁴ each represents an alkyl group or an aryl group; Z² represents an oxygen atom or a sulfur atom; R²⁵ and R²⁶ each represents an alkyl group, a fluorinated hydrocarbon group, an aryl group, an alkoxy group, an aryloxy group, an alkylthio group, or an arylthio group; m2, n2, and p2 each represents an integer of 0-4; and X is the same as defined for X in Formula (1).

(11) The resist composition described in above Item (10), wherein the sulfonium salt compound represented by Formula (2) incorporated in the resist composition described in above Item (10) is a compound represented by following Formula (3).

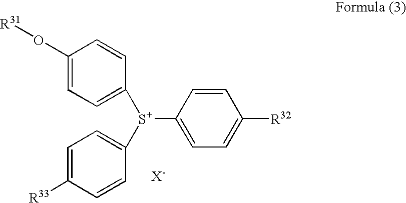

wherein R³¹ represents an alkyl group having 1-10 carbon atoms; R³² represents an alkyl group having 1-10 carbon atoms or an alkoxy group having 1-10 carbon atoms; and X is the same as defined for X in Formula (1).

(12) The resist composition described in above Item (10), wherein the sulfonium salt compound represented by Formula (2) incorporated in the resist composition described in above Item (10) is a compound represented by the following Formula (4).

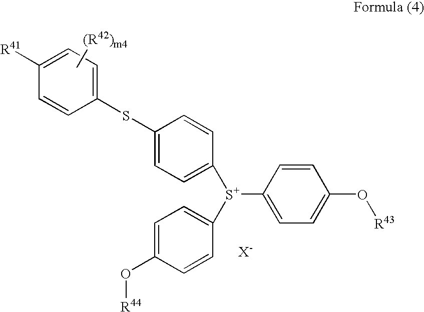

wherein R⁴¹ represents a hydrogen atom or an alkyl group having 1-10 carbon atoms; R⁴² represents a substituent; m4 represents an integer of 0-4; R⁴³ and R⁴⁴ each represents an alkyl group having 1-10 carbon atoms, and X is the same as defined for X of Formula (1).

(13) The resist composition described in above Item (10), wherein the sulfonium salt compound represented by Formula (2) incorporated in the resist composition described above Item (10) is a compound described by the following Formula (5).

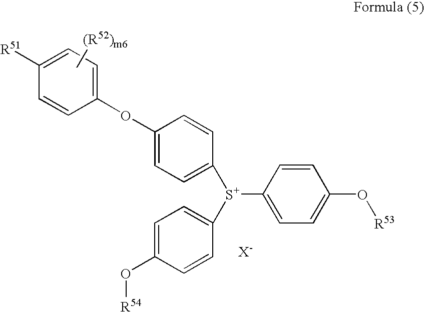

wherein R⁵¹ represents a hydrogen atom or an alkyl group having 1-10 carbon atoms; R⁵² represents a substituent; m5 represents an integer of 0-4; R⁵³ and R⁵⁴ each represent an alkyl group having 1-10 carbon atoms, and X is the same as defined for X of Formula (1).

Based on the present invention, it was possible to provide a photocurable composition incorporating a sulfonium salt which does not release benzene which is hazardous to humans and which results in excellent standing stability, and a resist composition.

### BRIEF DESCRIPTION OF THE DRAWINGS

FIG. 1 is a series of schematic views showing a resist pattern forming method employing the resist composition of the present invention.

### DESCRIPTION OF THE PREFERRED EMBODIMENT

The present invention will now be detailed. The present invention is characterized in employing the sulfonium salt compounds represented by Formula (1). Of the sulfonium salt compounds represented by Formula (1) of the present invention, preferred are those represented by Formulas (2)-(5) of the present invention, but particularly preferred are those represented by Formula (3). Further, when the compounds represented by Formulas (1)-(5) are employed in photocurable compositions, counter anion X is Z—SO₃ (Z represents CₙF₂ₙ₊₁, wherein n represents 1-10, an alkyl group, or an alkyl substituted or unsubstituted aryl group), BF₄, AsF₆, B(C₆F₅)₄, ClO₄, Br, Cl, or I; of which CF₃SO₃, BF₄, AsF₆, B(C₆F₅)₄ are preferred. When employed in a photoresist, CF₃SO₃ is particularly preferred.

(Compounds Represented by Formula (1))

In Formula (1), R¹¹ and R¹² each represent an alkyl group or an aryl group.

An alkyl group may be straight, branched, or cyclic. Examples include a methyl group, an ethyl group, a propyl group, an isopropyl group, a tert-butyl group, a pentyl group, a hexyl group, an octyl group, a dodecyl group, a tridecyl group, a tetradecyl group, a pentadecyl group, a cyclopentyl group, and a cyclohexyl group.

The aromatic ring may be either an aromatic hydrocarbon ring group or an aromatic heterocyclyl group, which may incorporate a condensed ring. Examples include an aromatic hydrocarbon group (for example, a phenyl group and a naphthyl group), as well as an aromatic heterocyclyl group (for example, a furyl group, a thienyl group, a pyridyl group, a pyridazyl group, a pyrimidyl group, a pirazyl group, a triazyl group, an imidazolyl group, a pyrazolyl group, a thiazolyl group, a benzimidazolyl group, a benzoxazolyl group, a quinazolyl group, and a phthalazyl group).

The above alkyl or aryl groups may further have substituents, a plurality of which may be joined together to form a ring or and may have a condensed ring. Examples of substituents other than the alkyl group described above include an alkenyl group (for example, an vinyl group or an allyl group); an alkynyl group (for example, an ethynyl group or a propagyl group); an aromatic hydrocarbon group (for example, a phenyl group or a naphthyl group); a heteroaryl group (for example, a furyl group, a thienyl group, a pyridyl group, a pyridazyl group, a pyrimidyl group, a pyrazyl group, a triazyl group, an imidazolyl group, a pyrazolyl group, a thiazolyl group, a benzimidazolyl group, benzoxazolyl group, a quinazolyl group, or a phthalazyl group; a heterocyclyl group (for example, a pyrrolidyl group, an imidazolydyl group, a morpholino group, or an oxazolydyl group); an alkoxy group (for example, a methoxy group, an ethoxy group, a propyloxy group, a pentyloxy group, a hexyloxy group, an octyloxy group, or a dodecyloxy group); a cycloalkoxy group (for example, a cyclopentyloxy group or a cyclohexyloxy group); an aryloxy group (for example, a phenoxy group or a naphthyloxy group); an alkylthio group (for example, a methylthio group, an ethylthio group, a propylthio group, a hexylthio group, an octylthio group, or a dodecylthio group); a cycloalkylthio group (for example, a cyclopentylthio group or a cyclohexylthio group); an arylthio group (for example, a phenylthio group or a naphthylthio group); an alkoxycarbonyl group (for example, a methyloxycarbonyl group, an ethyloxycarbonyl group, a butyloxycarbonyl group, an octyloxycarbonyl group, or a dodecyloxycarbonyl group); an aryloxycarbonyl group (for example, a phenyloxycarbonyl group or a naphthyloxycarbonyl group); a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, or a 2-pyridylaminosulfonyl group); an acyl group (for example, an acetyl group, an ethylcarbonyl group, a propylcarbonyl group, a pentylcarbonyl group, a cyclohexylcarbonyl group, an octylcarbonyl group, a 2-ethylhwexylcarbonyl group, a dodecylcarbonyl group, a phenylcarbonyl group, a naphthylcarbonyl group, or a pyridylcarbonyl group); an acyloxy group (for example, an acetyloxy group, an ethylcarbonyloxy group, a butylcarbonyloxy group, an octylcarbonyloxy group, a dodecylcarbonyloxy group, or a phenylcarbonyloxy group); an amido group (for example, a methylcarbonylamino group, an ethylcarbonylamino group, a dimethylcarbonylamino group, a propylcarbonylamino group, a pentylcarbonylamino group, a cyclohexylcarbonylamino group, a 2-ethylhexylcarbonylamino group, an octylcarbonylamino group, a dodecylcabonylamino group, a phenylcarbonylamino group, or a naphthylcarbonylamino group); a carbamoyl group (for example, an aminocarbonyl group, a methylcarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecylaminocarbonyl group, a phenylaminocarbonyl group, a naphthylaminocarbonyl group, or a 2-pyridylaminocarbonyl group); a ureido group (for example, a methylureido group, an ethylureido group, a pentylureido group, a cyclohexylureido group, an octylureido group, a dodecylureido group, a phenylureido group, a naphthylureido group, or a 2-pyridylaminoureido group); a sulfinyl group (for example, a methylsulfinyl group, an ethylsulfinyl group, a butylsulfinyl group, a cyclohexylsulfinyl group, a 2-ethylhexylsulfinyl group, a dodecylsulfinyl group, a phenylsulfinyl group, a naphthylsulfinyl group, or a 2-pyridylsulfinyl group); an alkylsulfonyl group (for example, a methylsulfonyl group, an ethylsulfonyl group, a butylsulfinyl group, a cyclohexylsulfonyl group, a 2-ethylhexylsulfonyl group, or a dodecylsulfonyl group); an arylsulfonyl group (for example, a phenylsulfonyl group, a naphthylsulfonyl group, or a 2-pyridylsulfonyl group); an amino group (for example, an amino group, an ethylamino group, a dimethylamino group, a butylamino group, a cyclopentylamino group, a 2-ethylhexylamino group, a dodecylamino group, an anilino group, a naphthylamino group, or a 2-pyridylamino group); a halogen atom (for example, a fluorine atom, a chlorine atom, or a bromine atom); a fluorinated hydrocarbon group (for example, a fluoromethyl group, a trifluoromethyl group, a pentafluoroethyl group, or a pentafluorophenyl group); a cyano group, a nitro group, a hydroxyl group, a mercapto group; a silyl group (for example, a trimethylsilyl group, a triisopropylsilyl group, a triphenylsilyl group, or a phenyldiethylsilyl group). These substituents may be substitute for the substituents described above, and a plurality of these substituents may be joined together to form a ring.

The alkyl or aryl groups represented by R¹¹ and R¹² may further be substituted. It is preferable that they are unsubstituted or are substituted with halogen atoms, but it is more preferable that they are unsubstituted alkyl groups or aryl groups, or aryl groups substituted with an alkoxy group. Examples of alkyl groups substituted with fluorine atoms include a fluoromethyl group, a trifluoromethyl group, a pentafluoroethyl group, and a pentafluorophenyl group.

Z¹ represents an oxygen atom or a sulfur atom. It is preferable that Z¹ is bonded at the ortho or para position with respect to the benzene ring which is bonded to a sulfonium ion but it is more preferable that it is bonded at the para position.

R¹³ and R¹⁴ each represent an alkyl group, an aryl group, an alkoxy group, an aryloxy group, an alkylthio group, and an arylthio group.

The above alkyl group and aryl group are each as defined for R¹¹ and R¹².

The above alkoxy group and aryloxy group each refer to the group which is formed in such a manner that one position of the group which is as defined for aforesaid R¹¹ and R¹² bonds to an oxygen atom. Listed as such a group are an alkoxy group (for example, a methoxy group, an ethoxy group, a propyloxy group, a pentyloxy group, a hexyloxy group, an octyloxy group, a dodecyloxy group, a fluoromethyl group, a trifluoromethyl group, or a pentafluoromethyl group), a cycloalkoxy group (for example, a cyclopentyloxy group or a cyclohexyloxy group), and an aryloxy group (for example, a phenoxy group or a naphthyloxy group).

The alkylthio group and arylthio group refer to a group which is formed in such a manner that one position of the group which is as defined for aforesaid R¹¹ and R¹² bonds to a sulfur atom. Examples include an alkylthio group (for example, a methylthio group, an ethylthio group, a propylthio group, a pentylthio group, a hexylthio group, an octylthio group, or a dodecylthio group), a cycloalkylthio group (for example, a cyclopentylthio group or a cyclohexylthio group), and an arylthio group (for example, a phenylthio group or a naphthylthio group). The aforesaid aryl group, aryloxy group, and arylthio group may have a condensed ring.

The above alkyl group, aryl group, alkoxy group, aryloxy group, alkylthio group, and arylthio group may further have substituent(s), and a plurality of these substituents may be joined together to form a ring and may have a condensed ring. Listed as examples of the aforesaid substituents may be those as defined in the examples of the substituents of above R¹¹. These substituents may further be substituted with substituent(s). Further, a plurality of these substituents may be joined together to form a ring. The alkyl group, aryl group, alkoxy group, aryloxy group, alkylthio group, and arylthio group represented by R¹³ and R¹⁴ may further have, or not have substituents. Of these, preferred are an unsubstituted alkyl group, aryl group, alkoxy group, aryloxy group, alkylthio group, and arylthio group, as well as an alkyl group substituted with halogen atom(s) and an aryl group substituted with alkoxy group(s). More preferred are an unsubstituted alkyl group, aryl group, alkoxy group, aryloxy group, alkylthio group, and arylthio group, as well as an alkyl group substituted with fluorine atom(s) and an aryl group substituted with alkoxy group(s). Examples of alkyl groups substituted with fluorine atom(s) include a fluoromethyl group, a trifluoromethyl group, a pentafluoroethyl group, and a pentafluorophenyl group.

m1 represents an integer of 0-4, is preferably an integer of 0-3, but is more preferably an integer of 0-2, while n1 and p1 each represent an integer of 1-5, are preferably an integer of 1-3, but are more preferably an integer of 1-2.

A plurality of R¹², R¹³ and R¹⁴ may be the same or different. R¹¹ and R¹² or a plurality of R¹² may be joined together to form a ring. R¹² and R¹³ or a plurality of R¹³ may be joined together to from a ring. R¹² and R¹⁴ or a plurality of R¹⁴ may be joined together to form a ring, while R¹² and R¹⁴ may be joined together to form a ring. At least one of R¹³ is preferably bonded at the ortho or para position with respect to the benzene ring combined with a sulfonium ion, but is bonded more preferably at the para position. At least one of R¹⁴ is preferably joined at the ortho or para position with respect to the benzene ring combined with a sulfonium ion, but is more preferably bonded at the para position. X represents Z-SO₃ (in which Z represents CₙF₂ₙ₊₁ where n represents 1-10, an alkyl group, or an alkyl-substituted or alkyl-unsubstituted aryl group), BF₄, AsF₆, SbF₆, B(C₆H₅), ClO₄, Br, Cl, or I.

(Compounds Represented by Formula (2))

In Formula (2), R²¹, R²², R²³, and R²⁴ each represent an alkyl group or an aryl group. The alkyl group and aryl group are as defined for the group represented by R¹¹, R²¹, R²², R²³, and R²⁴ each may be the same or different. R²¹ and R²², or a plurality of R²² may be joined together to form a ring, while R²¹ R²², or a plurality of R²² may be joined together to form a ring. Further, R²³ and R²⁵, or a plurality of R²³ may be joined together to form a ring, while R²⁴ and R²⁶, or a plurality of R²⁴ may be joined together to from a ring. Still further, R₂₂ and R₂₃ may be joined together to form a ring, and R₂₃ and R₂₄ may be joined together to form ring, while R₂₂ and R₂₄ may be joined together to form a ring.

Z² represents an oxygen atom or a sulfur atom, and R²⁵ and R²⁶ each represent an alkyl group, an aryl group, an alkoxy group, an aryloxy group, an alkylthio group, or an arylthio group. The alkyl group, aryl group, alkoxy group, aryloxy group, alkylthio group, and arylthio group are each as defined for aforesaid R¹³, while m2, n2, and p2 each represent an integer of 0-4, are preferably an integer of 0-2, but are more preferably 0 or 1. X is as defined for X of aforesaid Formula (1).

(Compounds Represented by Formula (3))

In Formula (3), R³¹ represents an alkyl group having 1-10 carbon atoms, which may be straight, branched, or cyclic. Examples include a methyl group, an ethyl group, a propyl group, an isopropyl group, a tert-butyl group, a pentyl group, a hexyl group, a heptyl group, an octyl group, a tert-amyl group, a cyclopentyl group, or a cyclohexyl group, each of which may have substituent(s). The substituents are as defined for those of above R₁₁. R₃₁ is preferably an alkyl group having 1-6 carbon atoms, but is more preferably an alkyl group having 1-4 carbon atoms.

Each of R³² and R³³ represents an alkyl group having 1-10 carbon atoms or an alkoxy group having 1-10 carbon atoms. The alkyl groups are as defined for those represented by above R³¹, while the alkoxy groups are those in which the oxygen atom is combined at one position of the group which is as defined for above R³¹. Listed as examples of such alkoxy groups may be a methoxy group, an ethoxy group, a propyloxy group, an isopropyloxy group, a tert-butyloxy group, a pentyloxy group, a hexyloxy group, a heptyloxy group, an octyloxy group, a cyclopentyloxy group, or a cyclohexyloxy group. Each of R³² and R³³ is preferably an alkyl group having 1-6carbon atoms, or an alkoxy group having 1-6 carbon atoms, is more preferably an alkyl group having 1-4 carbon atoms or an alkoxy group having 1-4 carbon atoms, but is most preferably a methyl group or a methoxy group. X is as defined for X of above Formula (1).

(Compounds Represented by Formula (4))

In Formula (4), R⁴¹ represents an alkyl group having 1-10 carbon atoms. The alkyl group may be straight, branched, or cyclic. Examples include a methyl group, an ethyl group, a propyl group, an isopropyl group, a tert-butyl group, a pentyl group, a hexyl group, a heptyl group, and a cyclohexyl group, each of which may further have substituent(s). Examples of the substituents are as defined for each of R¹¹. R⁴¹ is preferably an alkyl group having 1-6 carbon atoms, is more preferably an alkyl group having 1-4 carbon atoms, but is most preferably a methyl group.

R⁴² represents a substituent, which is as defined for the substituents of R¹¹.

m4 represents an integer of 0-4, is preferably an integer of 0-2, but is more preferably 0 or 1.

Each of R⁴³ and R⁴⁴ represents an alkyl group having 1-10 carbon atoms. The alkyl groups are as defined for the groups of R³¹. Each of R⁴³ and R⁴⁴ is preferably an alkyl group having 1-6 carbon atoms, is more preferably an alkyl group having 1-4 carbon atoms, but is most preferably a methyl group. X is as defined for X of above Formula (1).

(Compounds Represented by Formula (5))

In Formula (5), R⁵¹ represents a hydrogen atom or an alkyl group having 1-10 carbon atoms. The alkyl groups are as defined for the substituents of above R³¹. R⁵¹ is preferably a hydrogen atom or an alkyl group having 1-6 carbon atoms, but is more preferably a hydrogen atom or an alkyl group having 1-4 carbon atoms.

R⁵² represents a substituent, which is as defined for those of above R¹¹.

m5 represents an integer of 0-4, is preferably an 0-2, but is more preferably 0 or 1.

Each of R⁵³ and R⁵⁴ represents an alkyl group having 1-10 carbon atoms. The alkyl groups are as defined for R³¹. Each of R⁵³ and R⁵⁴ is preferably an alkyl group having 1-6 carbon atoms, is more preferably an alkyl group having 1-4 carbon atoms, but is most preferably a methyl group. X is as defined for X of above Formula (1).

Specific examples of the triarylsulfonium salt compounds represented by Formulas (1)-(5) will now be shown below, however the present invention is not limited thereto.

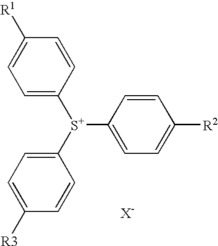

| | R¹ | R² | R³ | X⁻ |
|---|---|---|---|---|
| TAS-1 | —OCH₃ | —OCH₃ | —OCH₃ | CF₃SO₃⁻ |
| TAS-2 | —OCH₃ | —OCH₃ | —CH₃ | CF₃SO₃⁻ |
| TAS-3 | —OCH₃ | —CH₃ | —CH₃ | CF₃SO₃⁻ |
| TAS-4 | —CH₃ | —CH₃ | —CH₃ | CF₃SO₃⁻ |
| TAS-5 | —OCF₃ | —OCF₃ | —OCF₃ | CF₃SO₃⁻ |
| TAS-6 | —OCF₃ | —OCF₃ | —CH₃ | CF₃SO₃⁻ |
| TAS-7 | —OCF₃ | —CH₃ | —CH₃ | CF₃SO₃⁻ |
| TAS-8 | —OCH₃ | —OCH₃ | —Bu(t) | CF₃SO₃⁻ |
| TAS-9 | —OCH₃ | —OCH₃ | 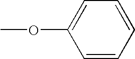 | CF₃SO₃⁻ |
| TAS-10 | —OCH₃ | —OCH₃ | 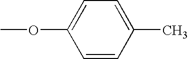 | |
| TAS-11 | —OCH₃ | —OCH₃ | 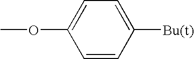 | CF₃SO₃⁻ |
| TAS-12 | —CH(CH₃)₂ | —CH(CH₃)₂ | 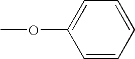 | CF₃SO₃⁻ |
| TAS-13 | —CH₃ | —CH₃ | 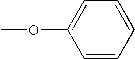 | CF₃SO₃⁻ |
| TAS-14 | —CH₃ | —CH₃ | 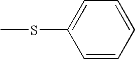 | CF₃SO₃⁻ |
| TAS-15 | 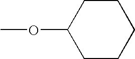 | 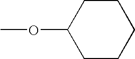 | 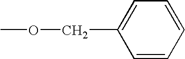 | CF₃SO₃⁻ |
| TAS-16 | —OCH₃ | —OCH₃ | 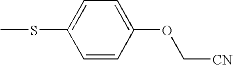 | CF₃SO₃⁻ |
| TAS-17 | —OCH₃ | —OCH₃ | 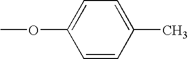 | CF₃SO₃⁻ |
| TAS-18 | —CH₃ | —CH₃ | 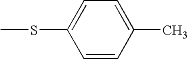 | CF₃SO₃⁻ |
| TAS-19 | —OCF₃ | —OCF₃ | 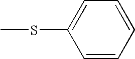 | CF₃SO₃⁻ |
| TAS-20 | —OCF₃ | —OCF₃ | 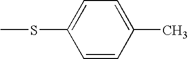 | CF₃SO₃⁻ |
| TAS-21 | —OCF₃ | —OCF₃ | 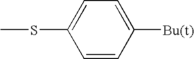 | CF₃SO₃⁻ |
| TAS-22 | —OCF₃ | —OCF₃ | 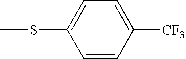 | CF₃SO₃⁻ |
| TAS-23 | —OC₂F₅ | —OC₂F₅ | 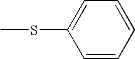 | CF₃SO₃⁻ |
| TAS-24 | —OC₂F₅ | —OC₂F₅ | 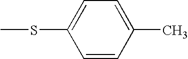 | CF₃SO₃⁻ |
| TAS-25 | —OCH₃ | —OCH₃ | —OCH₃ | BF₄⁻ |
| TAS-26 | —OCH₃ | —OCH₃ | —CH₃ | BF₄⁻ |
| TAS-27 | —OCH₃ | —CH₃ | —CH₃ | BF₄⁻ |
| TAS-28 | —CH₃ | —CH₃ | —CH₃ | BF₄⁻ |
| TAS-29 | —OCH₃ | —OCH₃ | —OCH₃ | B(C₆F₅)₄⁻ |
| TAS-30 | —OCH₃ | —OCH₃ | —CH₃ | B(C₆F₅)₄⁻ |
| TAS-31 | —OCH₃ | —CH₃ | —CH₃ | B(C₆F₅)₄⁻ |
| TAS-32 | —CH₃ | —CH₃ | —CH₃ | B(C₆F₅)₄⁻ |

| | |
|---|---|
| TAS-33 | 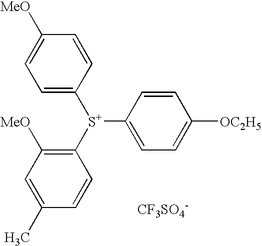 |
| TAS-34 | 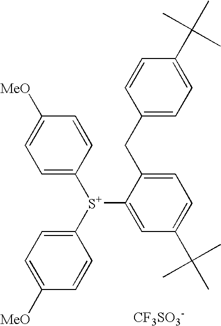 |
| TAS-35 | 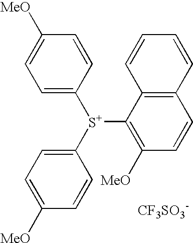 |
| TAS-36 | 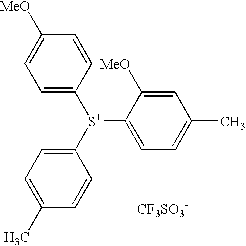 |
| TAS-37 | 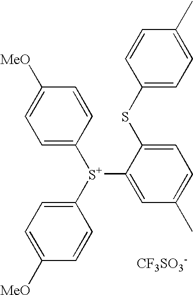 |
| TAS-38 | 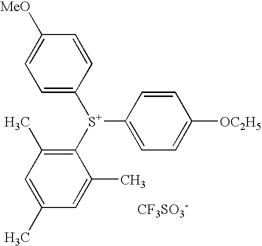 |
| TAS-39 | 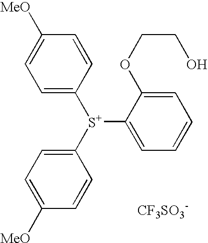 |
| TAS-40 | 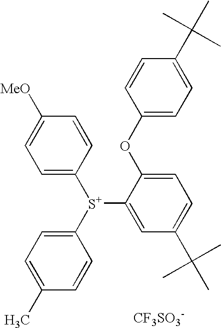 |
| TAS-41 | 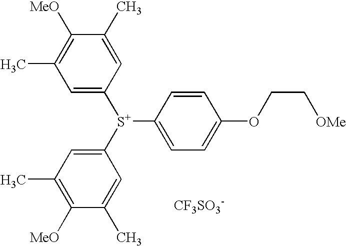 |
| TAS-42 | 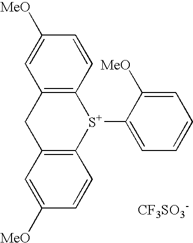 |
| TAS-43 | 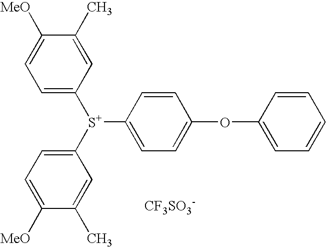 |
| TAS-44 | 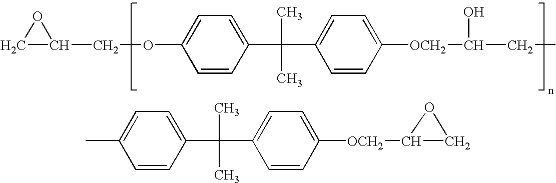 |
| TAS-44′ | 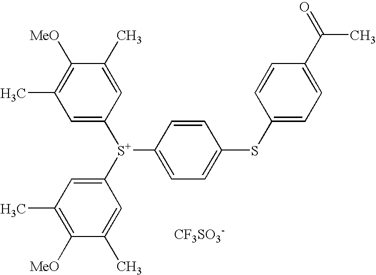 |
| TAS-45 | 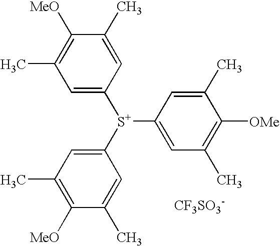 |
| TAS-46 | 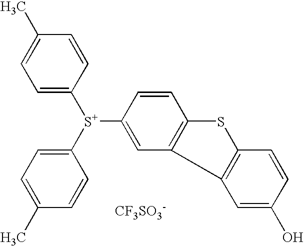 |
| TAS-47 | 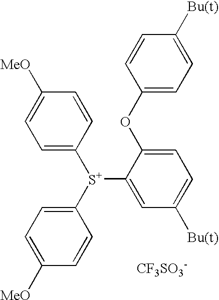 |
| TAS-48 | 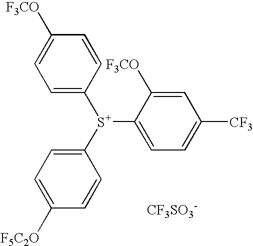 |
| TAS-49 | 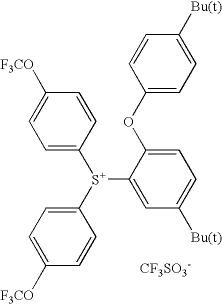 |
| TAS-50 | 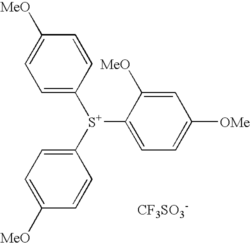 |

It is possible to synthesize these compounds based on the methods described in Bull. Chem. Soc. Jpn., 42, 312 (1969), J. Polym. Sci., Polym. Chem. Ed., 17, 2877 (1979); JP-A Nos. 11-80118, 2002-241474, and 2005-139425; and U.S. Pat. No. 4,404,459.

Preferably employed as oligomers having a molecular weight of 800-200,000 are negative working resist compounds represented by Formulas (6)-(11) below.

First, the compounds represented by Formula (6), capable of being preferably employed as the oligomers of a molecular weight of 800-200,000 of the present invention, will now be described.

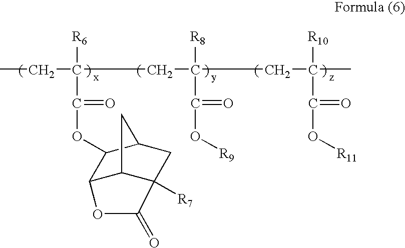

wherein R₆, R₇, R₈, and R₁₀ each represent a hydrogen atom or a methyl group; R₉ represents a group which undergoes decomposition by acid or a crosslinking cyclic hydrocarbon group having 7-13 carbon atoms, which undergoes decomposition by acid, or incorporates a group which undergoes decomposition by acid; and R₁₁ represents a hydrogen atom, a hydrocarbon group having 1-12 carbon atoms, or a crosslinking cyclic hydrocarbon group having 7-13 carbon atoms, which incorporates a carboxyl group; and further, x, y, and z each represent any number satisfying x+y+z=1, 0<x<1, 0<y<1, and 0≦z<1. Further, the average molecular weight of polymers is 2,000-200,000.

Alternatively, preferred are the polymers represented by following Formula (7) described in Japanese Patent Publication No. 2856116. 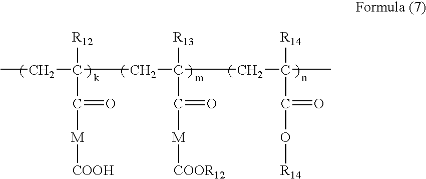
wherein R₁₂, R₁₃, and R₁₄ each represents a hydrogen atom or a methyl group; M represents a group having a crosslinking cyclic hydrocarbon group having 7-13 carbon atoms; R₁₄ represents a hydrogen atom or a hydrocarbon group having 1-12 carbon atoms; further k, m, and n each represent any number satisfying k+m+n=1, 0<k<1, 0<m<1, and 0≦n<1. Further, the average molecular weight of polymers is 2,000-200,000.

Further, it is possible to cite the polymers represented by following Formula (8) described in Journal of Photopolymer Science and Technology, Volume 10, Number 4, 545-550 (1997). 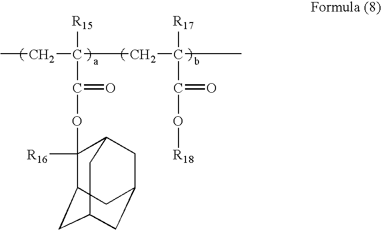
wherein R₁₅, R₁₆, and R₁₇ each represent a hydrogen atom or a methyl group; R₁₈ represents a group having a lactone structure; and further a and b each represent any number satisfying a+b=1, 0<a<1, and 0<b<1. Further, the average molecular weight of polymers is 2,000-200,000.

Still further, it is possible to cite the polymers represented by following Formula (9) described in Journal of Photopolymer Science and Technology, Volume 10, Number 3, 511-520 (1997). 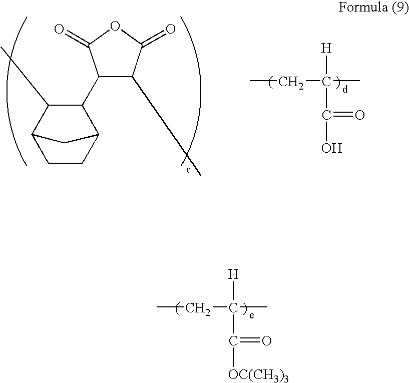
wherein c, d, and e each represent any number satisfying c+d+e=1, 0≦c<1, 0<d<1, and 0<e<1. Further, the average molecular weight of polymers is 2,000-200,000.

In case that the compounds represented by Formula (1) in JP-A No. 2003-177535 or the compounds represented by Formula (1) in JP-A No. 11-72917 are used as a negative resist material, a cross linking compound represented by Formula (2) in JP-A No. 11-72917 is preferably used.

It is also possible to suitably employ the polymers represented by following Formula (10) described in Journal of Photopolymer Science and Technology, Volume 12, Number 3, 487-492 (1999). 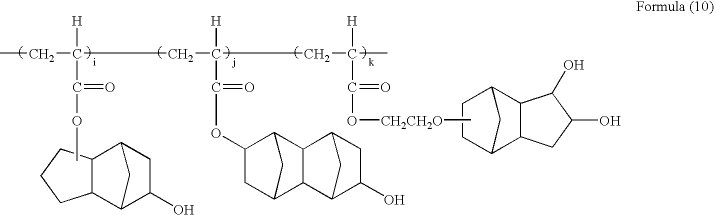
wherein i, j, and k each represent any number satisfying i+j+k=1, 0≦i<1, 0<j<1, and 0<k<1. Further, the average molecular weight of polymers is 2,000-200,000. 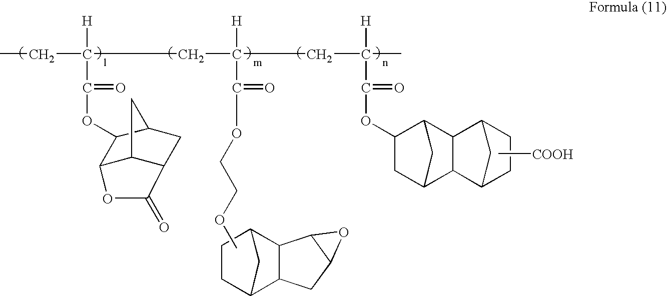
wherein l, m, and n each represent any number satisfying l+m+n=1, 0≦l<1, 0<m<1, and 0<n<1. Further, the average molecular weight of polymers is 2,000-200,000.

When employed as a negative resist material, it is possible to employ the compounds represented by Formula (1) of JP-A No. 2001-177535, the compounds represented by Formula (1) of JP-A No. 11-7297, and condensation products of n≧2 of bisphenol A with the epichlorohydrin described in JP-A No. 9-31390.

If the oligomers of a molecular weight of 800-200,000 are not incorporated, when employed as a negative resist material, photographic speed and etching durability have been insufficient.

When the compounds represented by Formula (1) of JP-A No. 2003-177535, as well as the compounds represented by Formula (1) of JP-A No. 11-72917, are employed as resist materials, it is preferable to employ the compounds represented by Formula (2) of JP-A No. 1172917 as a crosslinking agent.

The photocurable composition of the present invention will now be described.

It is preferable that the photocurable composition of the present invention incorporates a photopolymerizable monomer as a cationically curable compound. Employed as such photopolymerizable monomers may be various cationically polymerizable monomers known in the art, which include epoxy compounds, vinyl ether compounds, and oxetane compounds exemplified, for example, in JP-A Nos. 61-9714, 20001-31892, 2001-40068, 2001-55507, 2001-310938, 2001-310937, and 2001-220526.

Cited as such epoxy compounds are the following aromatic epoxides, alicyclic epoxides, and aliphatic epoxides.

Those preferred as aromatic epoxides are di- or polyglycidyl ethers which are prepared by allowing polyhydric phenol having at least one aromatic nucleus or a polyalkylene oxide addition product thereof to react with epichlorohydrin. Examples include di- or polyglycidyl ether of bisphenol A or an alkylene oxide addition product thereof, di- or polyglycidyl ether of bisphenol A or an alkylene oxide addition product thereof, di- or polyglycidyl ether of hydrogenated bisphenol A or an alkylene oxide addition product thereof, and novolak type epoxy resins. Cited as such alkylene oxides are ethylene oxide and propylene oxide.

Preferred as such alicyclic epoxides are compounds incorporating cyclohexane oxide or cyclopentane oxide, which are prepare by epoxidizing a compound having at least one cycloalkane ring, such as a cyclohexane or cyclopentane, employing appropriate oxidizing agents such as hydrogen peroxide or peracid.

Preferred aliphatic epoxides include di- or polyglycidyl ether of aliphatic polyhydric alcohol or alkylene oxide addition products thereof. Their representative examples include diglycidyl ether of alkylene glycol such as diglycidyl ether of ethylene glycol, diglycidyl ether of propylene glycol, or diglycidyl ether of 6-hexanediol; polyglycidyl ether of polyhydric alcohol such as glycerin or di- or triglycidyl ether of alkylene oxide addition products thereof; diglycidyl ether of polyethylene glycol or alkylene oxide addition products thereof; and diglycidyl ether of polyalkylene glycol such as polypropylene glycol or alkylene oxide addition products thereof. Herein, cited as alkylene oxides are ethylene oxide and propylene oxide.

Of these epoxides, in view of quick curing properties, preferred are aromatic epoxides and alicyclic epoxides, but the alicyclic epoxides are particularly preferred. In the present invention, the above epoxides may be employed individually or in combination.

Further, in the present invention, preferred as alicyclic epoxy compounds are those represented by Formulas (A), (I)-(VI) described in JP-A No. 2005-139425.

In the present invention, cited as vinyl ether compounds which are preferably added to photocurable compositions may be vinyl ether compounds known in the art.

Examples include di- or trivinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexane dimethanol divinyl ether, or trimethylolpropane trivinyl ether, and monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl ether-O-propylene carbonate, dodecyl vinyl ether, diethylene glycol monovinyl ether, or octadecyl vinyl ether.

Of these vinyl ether compounds, when curability, adhesion, and surface hardness are considered, di- or trivinyl ether compounds are preferred but divinyl ether compounds are particularly preferred. In the present invention, the above vinyl ether compounds may be employed individually or in combinations of at least two types.

Listed as oxetane compounds usable in the present invention may be any of the conventional oxetane compounds disclosed, for example, in JP-A Nos. 2001-220526 and 2001-310937. Specifically preferred are the compounds represented by Formula (E), described in JP-A No. 2005-1394525, and it is possible to list, as the specific compounds, E-1-E-13 described in paragraph number 0218 of the above patent.

Further, in order to enhance layer strength after curing, it is more preferable that in the photocurable composition of the present invention, monofunctional oxetane compounds having a single oxetane ring, are employed together with polyfunctional oxetane compounds having at least two oxetane rings. However, when compounds having at least 5 oxetane rings are employed, ease of handling suffers due to an increase in viscosity of the photocurable composition, and adhesion properties becomes unsatisfactory due to an increase in the glass transition temperature of the photocurable compositions. Consequently, it is preferable that the oxetane ring containing compounds employed in the present invention have 1-4 oxetane rings.

In the present invention, it is preferable that as photopolymerizable compounds, incorporated are 25-90 percent by weight oxetane ring containing compounds, 10-70 percent by weight of oxysilane group-containing compounds, and 0-40 percents by weight vinyl ether containing compounds, whereby both curability and ejection stability are enhanced.

It is possible to incorporate, in the photocurable composition of the present invention, various additives other than those cited above. For example, it is possible to add leveling additives, matting agents, as well as polyester based resins, polyurethane based resins, vinyl based resins, acryl based resins, rubber based resins, and waxes, all of which are employed to control various physical layer properties.

The photocurable ink composition of the present invention incorporates a pigment dispersion. It is possible to list the following pigments which are usable in the present invention:

C.I. Pigment Yellow-1, 3, 12, 13, 14, 17, 42, 81, 83, 87, 95, 109, 114, 120, 128, 129, 138, 160, 151, 154, 180, and 185;

C.I. Pigment Orange-16, 36, and 38;

C.I. Pigment Red-5, 22, 38, 48:1, 48:2, 48:4, 49:1, 53:1, 57:1, 63:1, 101, 122, 123, 144, 146, 168, 1984, 185, and 202;

C.I. Pigment Violet-19 and 23;

C.I. Pigment Blue-15:1, 15:3, 15:4, 18, 27, 29 and 60;

C.I. Pigment Green-7 and 36;

C.I. Pigment White-6, 18, and 21; and

C.I. Pigment Black-7.

To disperse the above pigments, it is possible to employ, for example, a ball mill, a sand mill, an attritor, a roller mill, an agitator, a Henschel mixer, a colloid mill, an ultrasonic homogenizer, a pearl mill, a wet-system jet mill, or a paint shaker. During dispersion of pigments, it is possible to add dispersing agents. It is preferable that polymer dispersing agents are employed as such a dispersing agent. Listed as such polymers dispersing agents are, for example, the SOLSPERSE Series, available from Avecia Co. and the PB Series, available from Ajinomoto Fine Techno Co. Further, as a dispersion aid, it is possible to use synergists corresponding to each of various pigments. It is preferable that these dispersing agents and dispersion aids are added in quantities of 1-50 parts by weight with respect to 100 parts by weight of the pigments. Commonly employed as dispersion media are solvents or polymerizable compounds. However, in the photocurable ink of the present invention, it is preferred that no solvent is employed to perform reaction and curing after printing. When solvents remain in cured images, solvent resistance is degraded and the VOC problem of remaining solvents occurs. Consequently, it is preferable that dispersion media are not solvents but are polymerizable compounds. Of these, in view of dispersion adaptability, it is preferable to choose monomers exhibiting the lowest viscosity.

Upon dispersion of pigments, selection of the pigments, dispersing agents, and dispersing media, as well as determination of the dispersion conditions and filtration conditions are appropriately performed so that the average diameter of pigment particles reaches preferably 0.08-0.5 μm, and the maximum particle diameter reaches commonly 0.3-10 μm, but preferably 0.3-3 μm. According to such particle size management, it is possible to retard clogging of head nozzles and maintain desired storage stability of the ink, as well as transparency and curing speed of the same. In the ink of the present invention, the concentration of colorants is preferably 1-10 percent by weight with respect to the total ink.

It is possible to employ, in the photocurable ink of the present invention, various additives other than those described above. For example, it is possible to add leveling additives, matting agents, as well as polyester based resins, polyurethane based resins, vinyl based resins, acryl based resins, rubber based resins, and waxes, all of which are employed to control specific physical layer properties. Further, to improve storage stability, it is possible to employ any of the basic compounds known in the art. Listed as representative compounds are basic alkaline metal compounds, alkaline earth metal compounds, and basic organic compounds such as amine. Further, it is possible to prepare a radically cationic hybrid type curable ink by combining radically polymerizable monomers with initiators.

The viscosity of the ink of the present invention, when employed to form ink-jet images, is preferably 7-50 mPa·s at 25° C.

Other than common non-coated and coated papers, employed as recording materials usable in present invention may be various non-absorptive plastics and films thereof, which are employed for so-called soft packaging. Listed as various plastic films may, for example, be polyethylene terephthalate (PET) film, oriented polystyrene (OPS) film, oriented polypropylene (OPP) film, oriented nylon (ONy) film, polyvinyl chloride (PVC) film, polyethylene (PE) film, and triacetyl cellulose (TAC) film. Employed as other plastics may be polycarbonates, acrylic resins, ABS, plyacetals-, polyvinyl alcohols (PVA), and various kinds of rubber. Further, it is also possible to employ various kinds of metal and glass. Of these recording materials, when images are formed on PET film, OPS film, OPP film, ONy film, or PVC film, all of which are specifically shrinkable while heated, the constitution of the present invention becomes effective. However, these substrate materials tend to curl and deform due to curing contraction and heat generation during the curing reaction, and further, the ink layer hardly follows contraction rate of the substrate.

The surface energy of each of the various types of these plastic films differs markedly and the resulting variation of the dot diameter after deposition of ink droplets has caused problems. The embodiment of the present invention enables the formation of highly detailed and excellent images on a wide range of recording materials at a surface energy in the range of 35-60 mN/m, including from OPP film and OPS film at a low surface energy to PET at a relatively large surface energy.

In the present invention, in view of recording material cost such as packaging and production cost, print production efficiency, and capability to correspond to prints of various sizes, it is more advantageous to employ a long-length (being a web) recording material.

The printing method of the present invention will now be described.

In the printing method in the present invention, a method is preferred in which the aforesaid ink is printed on recording materials, employing systems such as flexographic printing, gravure printing, or ink-jet recording, and subsequently, the resulting ink is cured by exposure to actinic radiation such as ultraviolet radiation.

In the present invention, it is preferable that after ink is employed to form images and cured by exposure to actinic radiation, the total ink layer thickness is preferably 2-20 μm. In the soft-package printing field, in which recording materials are composed of thin plastics, ink ejection resulting in excessive ink thickness is not preferred since problems occur in which the entire stiffness and the feel of quality are changed in addition to the aforesaid curling and wrinkling problems of the recording materials.

“Total ink layer thickness”, as described herein, refers to the maximum ink layer thickness formed on the recording material. Even when recording of a single color, two-overlapped colors (secondary color), three-overlapped colors, or four-overlapped colors (white ink base) is performed, the total ink layer thickness is defined as above.

In the printing method of the present invention, preferable exposure conditions to actinic radiation are that exposure to actinic radiation is performed preferably 0.001-2.0 seconds after printing employing the ink, but more preferably 0.001-1.0 second. In order to form highly detailed images, it is critical that exposure is performed as soon as possible after printing.

Further, one of the preferred embodiments is a method in which exposure to actinic radiation is divided into two stages, and initially, exposure is performed 0.001-2.0 seconds after printing employing the ink, and after printing an entire sheet, exposure to actinic radiation is further performed. By dividing exposure to actinic radiation into two stages, it is possible to retard contraction of the recording material, which occurs during curing.

Heretofore, in UV ink printing systems, in order to retard an increase in dot size and reduce bleeding after deposition of ink droplets, it has been common to use high illuminance radiation sources, the total electrical power consumption of at least 1 kW·hour. However, when such radiation sources are employed to perform printing onto shrinkable labels, recording materials excessively, whereby it has been impossible to employ such radiation sources. in practice.

In the present invention, it is preferable to employ actinic radiation of a maximum illuminance in the wavelength region of 254 nm. Even though the radiation source of the total electrical power consumption of less than or equal to 1 kW·hour is employed, it is possible to form highly detailed images and to control contraction of recording materials within practically allowable range.

In the present invention, it is preferable that the total electrical power consumption of the radiation source, which emits actinic radiation, is less than 1 kW·hour. Examples of radiation sources exhibiting a total electric power consumption of less than 1 kW·hour include, but are not limited to, fluorescent lamps, cold cathode tubes, and LEDs.

The resist composition of the present invention will now be described.

The resist composition of the present invention is one which incorporates the sulfonium salt compounds represented by Formula (1) and polymers having a protective group, and the above polymers are subjected to acid action to become alkali-soluble. These are described above.

Added to the resist composition of the present invention may be crosslinking agents which allow resins to crosslink in the exposed portions to become in-soluble. Listed as preferable crosslinking agents are urea-melamine based crosslinking agents such as hexamethoxymethylmelamine, 1,3,4,6-tetrakis(methoxymethyl)glycol urea, 1,3-bis(methoxymethyl)-4,5-bis(methoxymethyl)ethylene urea, or 1,3-bis(methoxymethyl)urea, as well as multifunctional epoxy compounds. Suitable crosslinking agents are not limited to those exemplified herein. Further, they may be added individually or in combinations of at least two types upon being blended. Still further, added may be polyhydric alcohols which are effective to enhancer crosslinking density as a crosslinking acceleration agent. Listed as such crosslinking acceleration agents are 2,3-dihydroxy-5-hydroxymethylnorbornane, 1,4-cyclohexanedimethanol, and 3,4,8(9)-trihydroxytricyclodecane.

Solvents, which are preferably employed in the resist composition of the present invention, are as follows. Any organic solvents may be used as long as they completely dissolve components composed of polymer compounds and sulfonium, and the resulting solution is capable of forming a uniformly coated layer, employing a spin coating method. Further, they may be employed individually or in combinations of at least two types. Specific examples include, but are not limited to, n-propyl alcohol, isopropyl alcohol, n-butyl alcohol, tert-butyl alcohol, methyl cellosolve acetate, ethyl cellosolve acetate, propylene glycol monoethyl ether acetate, methyl lactate, ethyl lactate, 2-methoxybutyl acetate, 2-ethoxyethyl acetate, methyl pyruvate, ethyl pyruvate, ethyl 3-methoxypropionate, N-methyl-2-pyrrolidinone, cyclohexanone, cyclopentanone, cyclohexanol, methyl ethyl ketone, 1,4-dioxane, ethylene glycol monomethyl ether, ethylene glycol monomethyl ether acetate, ethylene glycol monoethyl ether, ethylene glycol monoisopropyl ether, ethylene glycol monomethyl ether, and diethylene glycol dimethyl ether.

Further, other than essential constituting components of the above resist compositions, if desired, added may be surface active agents, colorants, stabilizers, coatability enhancing agents, and dyes. Still further, by employing the present invention, selected as a developer to form detailed patterns may be appropriate organic solvents, or mixtures thereof, or an aqueous alkali solution at an appropriate concentration or a mixture thereof with organic solvents, depending on solubility of the polymer compounds employed in the present invention. Further, if desired, other components such as surface active agents may be added to the developer. Listed as usable organic solvents are acetone, methyl ethyl ketone, methyl alcohol, isopropyl alcohol, tetrahydrofuran, and dioxane. Further, examples of the usable alkali solutions include, but are not limited to, solutions and aqueous solutions, incorporating inorganic alkalis such as sodium hydroxide, potassium hydroxide, sodium silicate, or ammonia; organic amines such as ethylamine, propylamino, diethylamine, dipropylamione, or trimethylamine; and organic ammonium salts such as tetramethylhydroxymethylammonium hydroxide triethylhydroxymethylammonium hydroxide, or trimethylhydroxyethylammonium hydroxide.

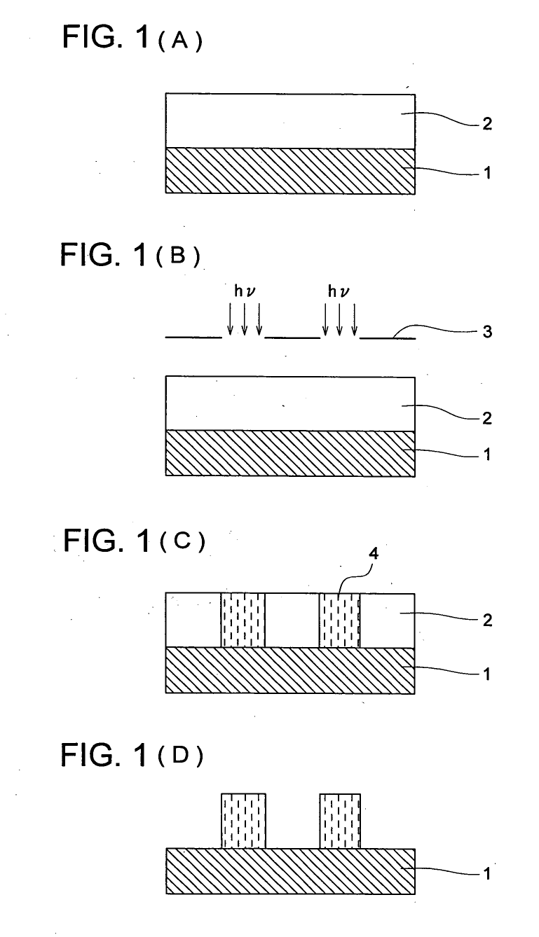

Further, in the present invention, it is possible to form a negative photoresist pattern on a substrate to be treated, employing the above resist composition. FIG. 1 shows a method to form a negative pattern employing the resist composition of the present invention.

Initially, as shown in FIG. 1(A), a resist composition is applied onto substrate 1 which is to be treated. Subsequently, by affecting a pre-bake treatment in the range of 60-170° C. for 30-240 seconds, employing a heating device such as a hot plate, resist layer 2 is formed. Thereafter, as shown in FIG. 1(B), resist layer 2 is selectively exposed through photomask 3 employing an exposure device. After the above exposure, resist layer 2 is thermally processed, whereby, as shown in FIG. 1(C), resins undergo crosslinking in exposed portion 4. Finally, as shown in FIG. 1(D), only the unexposed portion of resist layer 2 is selectively via dissolution employing an alkali developer such as an aqueous tetramethylammonium hydroxide (TMAH) solution, whereby a negative pattern is formed.

### EXAMPLES

The present invention will now be detailed with reference to examples, however the present invention is not limited thereto. All numerical values shown in the formulation of each table below are parts by weight.

### Example 1

The resist composition formulated in Table 1 was prepared. The following experiments were conducted under a yellow lamp.

Each of the mixtures described in Table 1 was filtered via a 0.2 μm TEFLON (registered trade name) filter, whereby Resist Composition Sample Nos. 11-17 were prepared. Each sample was spin-coated onto a 3-inch quartz substrate, and the resulting coating was heated on a hot plate at 100° C. for 60 seconds, whereby a 0.5 μm thick resist layer was formed. The resulting sample was allowed to stand in a contact-type exposure experimental instrument which was sufficiently purged by nitrogen. A mask in which a pattern had been drawn employing a chrome was brought into close contact with a quartz substrate in the form of a resist layer and then a KrF excimer laser beam (65 mJ/m²) was exposed through the above mask. Immediately after exposure, the sample was baked on a hot plate at 140° C. for 60 seconds, and then developed in a 2.38% aqueous tetramethylammonium hydroxide (TMAH) solution at 23° C. for 60 seconds, employing an impregnation method, followed by rinsing with pure water for 60 seconds.

Evaluation of Cleaning Property

The state after the rinsing was observed employing a microscope.
A: Unexposed portions were completely washed off
B: Slight deposit portions were noted in unexposed portions
C: Significant deposits were noted
   Evaluation of Photographic Speed

Curability was evaluated, when the exposure amount of KrF excimer laser was decreased to half the standard exposure amount (i.e. exposed to 32.5 mJ/m²). The evaluation was done according to the following criteria.
A: Exposed portions were sufficiently cured
B: Slight non-uniformity of curing was noted
C: Definite non-uniformity of curing was noted

Table 1 shows the results.

The compounds employed in Table 1 follow.

TABLE 1
Cel2021P: CELOXIDE 2021P (produced by Daicel Chemical Industries, Ltd.),
OXT221: di [1-ethyl (3-oxecetanyl)] methyl ether (produced by Toagosei Co., Ltd.),
MW30: a compound composed of Compound B1 as a main component (produced by Sanwa Chemical Co., Ltd.), and
Solv1: propylene glycol monomethyl ether acetate

| | |
|---|---|
| TAS-3 | 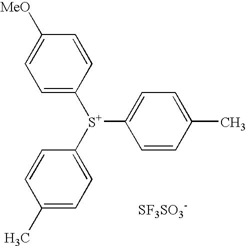 |

OL-1 (at an average
molecular weight of 28,000)

| | |
|---|---|
| S-1 | 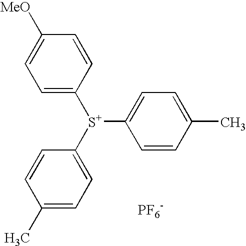 |
| | 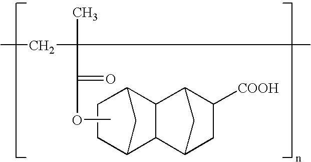 |

OL-2 (n = 2 at a molecular weight of 884)

| | |
|---|---|
| B-1 | 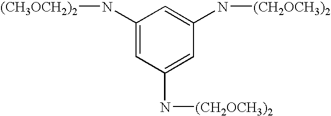 |
| | 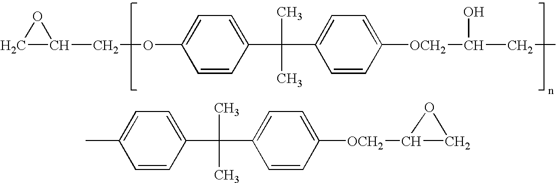 |

OL-3 (n = 1 at a molecular weight of 604)

| | 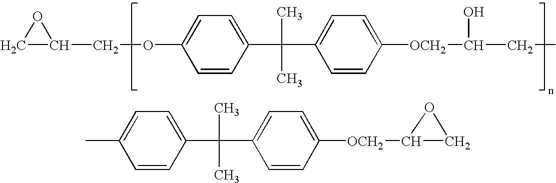 | | | | | | | | | | | |
|---|---|---|---|---|---|---|---|---|---|---|---|---|
| | | | | | | Epoxy | Oxetane | | | | | |
| | Initiator | | Oligomer | | | Compound | Compound | | Solvent | | Cleaning | |
| Sample | TAS-3 | S-1 | OL-1 | OL-2 | OL-3 | Ce12021P | OXT2121 | *1 | Solv1 | *2 | Property | Remarks |
| No.11 | 0.15 | | | | | | | 2.25 | 85 | A | A | Inv. |
| No.12 | | 2.5 | 12.6 | | | | | 2.25 | 85 | A | B | Comp. |
| No.13 | 2.5 | | | 30 | | | | | 65 | A | A | Inv. |
| No.14 | | 2.5 | | 15 | | 10 | 42.5 | | 30 | A | B | Comp. |
| No.15 | 2.5 | | | | | 30 | 67.5 | | | B | A | Comp. |
| No.16 | 2.5 | | | | 30 | | | | 65 | B | A | Comp. |
| No.17 | | 2.5 | | | 15 | 10 | 42.5 | | 30 | B | B | Comp. |

*1: Crosslinking Agent MW30,
*2: Photographic Speed
Inv.: Present Invention,
Comp.: Comparative Example

Based on Table 1, it is seen that the samples of the present invention exhibited desirable photographic speed and excellent cleaning property.

### Example 2

Each of the mixtures described in Table 2 was filtered via a 0.2 μm TEFLON (registered trade name) filter, whereby Resist Composition Sample Nos. 21-24 were prepared. Each sample was spin-coated onto a 7.62 cm (3-inch) quartz substrate, and the resulting coating was heated on a hot plate at 100° C. for 60 seconds, whereby a 0.5 μm thick resist layer was formed. The resulting sample was allowed to stand in a contact-type exposure experimental instrument which had been sufficiently purged by nitrogen. A mask in which a pattern had been drawn employing chrome was brought into close contact with the quartz substrate in the form of a resist layer and then a KrF excimer laser beam (65 mJ/m²) was exposed through the above mask. Immediately after exposure, the sample was baked on a hot plate at 140° C. for 60 seconds, and then developed in a 2.38% aqueous tetramethylammonium hydroxide (TMAH) solution at 23° C. for 60 seconds, employing an impregnation method, followed by rinsing for 60 seconds, employing pure water. Subsequently, cleaning property and photographic speed were evaluated in the same manner as in Example 1.

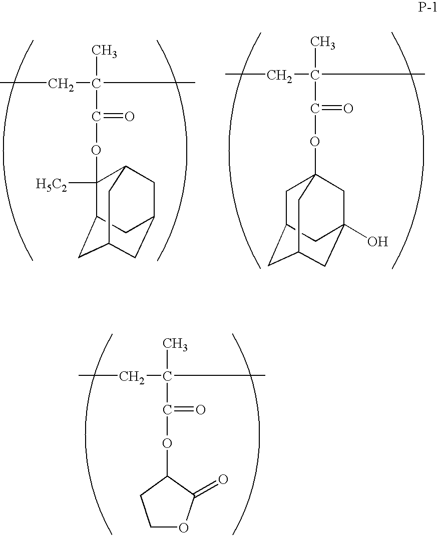

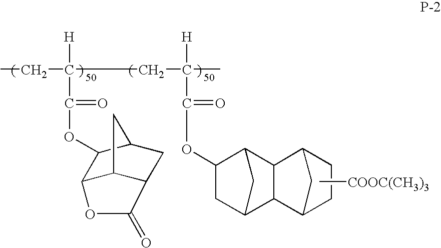

TABLE 2

| | Initiator | | Resin | | Solvent | | Photographic | Cleaning | |
|---|---|---|---|---|---|---|---|---|---|
| Sample | TAS-3 | S-1 | P-1 | P-2 | Solv1 | Solv2 | Speed | Property | Remarks |
| No. 21 | | 0.2 | 15 | | 79.8 | 5 | A | B | Comp. |
| No. 22 | 0.2 | | 15 | | 79.8 | 5 | A | A | Inv. |
| No. 23 | 0.15 | | | 15 | 79.85 | | A | A | Inv. |
| No. 24 | 0.15 | | | | 79.85 | | C | A | Comp. |

Solv2: γ-butyrolactone,
Inv.: Present Invention,
Comp.: Comparative Example

Based on Table 2, it is seen that the samples of the present invention exhibited desirable photographic speed and excellent cleaning property.

### Example 3

<<Preparation of Dispersion>>

Pigments were dispersed in the following composition.

The following two compounds were charged into a stainless steel beaker and heat-dissolved while stirring over one hour on a hot plate at 65° C.

| | |
|---|---|
| PB822 (dispersing agent produced by | 9 weight parts |
| Ajinomoto Fine Techno Co.) | |
| OXT-221 (produced by Toagosei Co., | 71 weight parts |
| Ltd.) | |

After cooling to room temperature, 20 parts by weight of Pigment Black (#52, produced by Mitsubishi Chemical Corp.) were added. The resulting mixture was charged into a glass bottle together with 200: g of zirconia beads at a diameter of 0.5 mm, sealed, and dispersed for 10 hours employing a paint shaker, followed by removal of the zirconia beads. A black pigment dispersion was thus prepared.

<<Preparation of Ink Composition>>

Ink Composition Sample Nos. 31-35 were prepared under the ink compositions described in Table 3, and filtered employing a 3 μm TEFLON (registered trade name) membrane filter, produced by ADVATEC Co. The resulting ink compositions were evaluated as follows.

<<Evaluation of Ink Composition>>

Evaluation of Ink Curability

Each ink composition was subjected to bar coating to reach a thickness of 5 μm on a polyethylene terephthalate film. Thereafter, the resulting coating was exposed for 0.1 second at an illuminance of 10 mW/cm² using a low pressure mercury lamp (UVPF-A1, made by Iwasaki Electric Co. Ltd. At 254 nm irradiation) on the substrate surfaced.

Ink curability was evaluated according to the following criteria with a finger.
A: Even though touched immediately after exposure, the coating exhibited no tackiness
B: When touched immediately after exposure, the coating exhibited some tackiness, but after one minute of exposure, exhibited no tackiness
C: Tackiness was exhibited after more than one minute of exposure
   Evaluation of Ink Stability

Each of the ink samples was stirred in a stainless steel beaker at 55° C. for 8 hours and deposits were evaluated prior to and after the stirring. Visual observation was done to evaluate stability of ink according to the following criteria.
A: No deposits were noted
B: Slight deposits were noted

C: Significant deposits were noted

TABLE 3

| | | | | | | | Pigment | | |
|---|---|---|---|---|---|---|---|---|---|
| | | | | | | | Dispersion | | |
| | Initiator | | Oligomer | | Epoxy | Oxetane | Pigment | Ink | Ink |
| | TAS-3 | S-1 | OL-2 | OL-3 | Cel2021P | OXT221 | Dispersion 1 | Curability | Stability |
| No. 31 | 5 | | 10 | | 27 | 45.5 | 12.5 | A | A |
| No. 32 | | 5 | 10 | | 27 | 45.5 | 12.5 | A | C |
| No. 33 | 5 | | | 10 | 27 | 45.5 | 12.5 | B | A |
| No. 34 | | 5 | | 10 | 27 | 45.5 | 12.5 | B | C |
| No. 35 | 2.5 | | | | 27 | 58 | 12.5 | B | A |

No. 31: Inventive sample
Nos. 32-35: Comparative sample

Based on Table 3, it is seen that the ink compositions of the present invention exhibited excellent curability and stability.

What is claimed is:

1. A photocurable composition comprising:
(i) a cationically curable oligomer having a molecular weight of 800-200,000; and
(ii) a sulfonium salt represented by Formula (1): 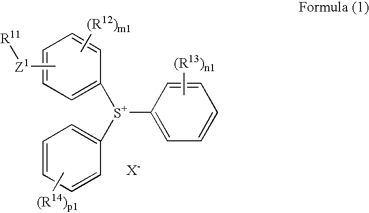
wherein R¹¹ and R¹² each represents an alkyl group or an aromatic group; Z¹ represents an oxygen atom or a sulfur atom; R¹³ and R¹⁴ each represents an alkyl group, an aromatic group, an alkoxy group, an aryloxy group, an alkylthio group, or an arylthio group; m1 represents an integer of 0-4; n1 and p1 each represents an integer of 1-5; X represents. Z-SO₃, (provided that Z represents CₙF₂ₙ₊₁, in which n represents an integer of 1-10, an alkyl group, a non-substituted aromatic group or an aromatic group having an alkyl substitution); BF₄, AsF₆, SbF₆, B(C₆F₅), ClO₄, Br, Cl, or I.

2. The photocurable composition of claim 1,
wherein the sulfonium salt represented by Formula (1) is further represented by Formula (2): 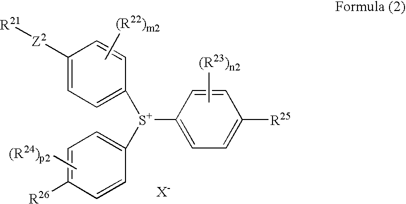
wherein R²¹, R²², R²³, and R²⁴ each represents an alkyl group or an aromatic group; Z² represents an oxygen atom or a sulfur atom; R²⁵ and R²⁶ each represents an alkyl group, a fluorinated hydrocarbon group, an aromatic group, an alkoxy group, an aryloxy group, an alkylthio group, or an arylthio group; m2, n2, and p2 each represents an integer of 0-4; and X is the same as defined for X in Formula (1).

3. The photocurable composition of claim 2,
wherein the sulfonium salt represented by Formula (2) is further represented by Formula (3): 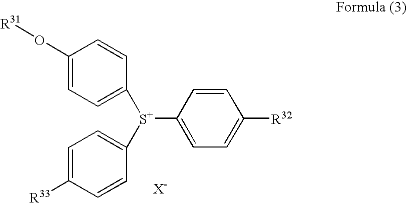
wherein R³¹ represents an alkyl group having 1-10 carbon atoms; R³² and R³³ each represents an alkyl group having 1-10 carbon atoms or an alkoxy group having 1-10 carbon atoms; and X is the same as defined for X in Formula (1).

4. The photocurable composition of claim 2,
wherein the sulfonium salt represented by Formula (2) is further represented by Formula (4): 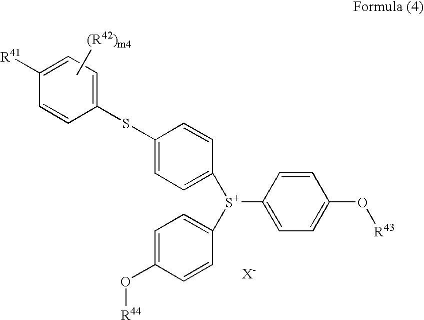
wherein R⁴¹ represents a hydrogen atom or an alkyl group having 1-10 carbon atoms; R⁴² represents a substituent; m4 represents an integer of 0-4; R⁴³ and R⁴⁴ each represents an alkyl group having 1-10 carbon atoms; and X is the same as defined for X of Formula (1).

5. The photocurable composition of claim 2,
wherein the sulfonium salt represented by Formula (2) is further represented by Formula (5): 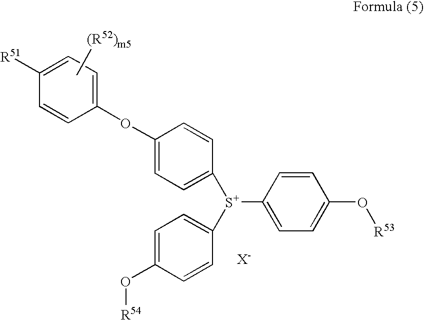
wherein R⁵¹ represents a hydrogen atom or an alkyl group having 1-10 carbon atoms; R⁵² represents a substituent; m5 represents an integer of 0-4; R⁵³ and R⁵⁴ each represents an alkyl group having 1-10 carbon atoms; and X is the same as defined for X of Formula (1).

6. The photocurable composition of claim 1, further comprising an epoxy compound, an oxetane compounds, or a vinyl ether compound.

7. The photocurable ink composition comprising the photocurable composition of claim 1 and a pigment dispersion.

8. A method of printing comprising the steps of:
forming an image employing the photocurable ink composition of claim 7; and
irradiation the image with actinic rays so as to cure the image.

9. A resist composition comprising:
(i) an oligomer having a molecular weight of 800-200,000 and a protected group, provided that the oligomer becomes alkali-soluble after being subjected to an acid; and
(ii) a sulfonium salt compound represented by Formula (1): 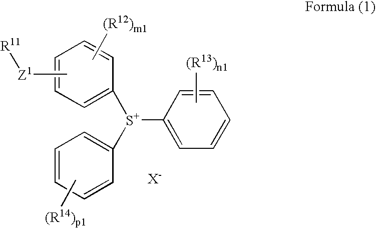
wherein R¹¹ and R¹² each represents an alkyl group or an aromatic group; Z¹ represents an oxygen atom or a sulfur atom; R¹³ and R¹⁴ each represents an alkyl group, an aromatic group, an alkoxy group, an aryloxy group, an alkylthio group, or an arylthio group; m1 represents an integer of 0-4; n1 and p1 each represents an integer of 1-5; X represents Z-SO₃, (provided that Z represents CₙF₂ₙ₊₁, in which n represents an integer of 1-10, an alkyl group, a non-substituted aromatic group, an aromatic group having an alkyl substitution); BF₄, AsF₆, SbF₆, B(C₆F5), ClO₄, Br, Cl, or I.

10. The resist composition of claim 9,
wherein the sulfonium salt represented by Formula (1) is further represented by Formula (2): 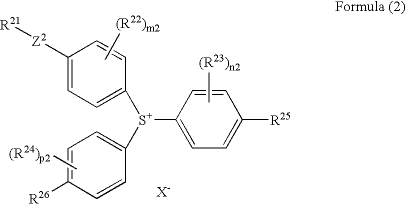
wherein R²¹, R²², R²³, and R²⁴ each represents an alkyl group or an aromatic group; Z² represents an oxygen atom or a sulfur atom; R²⁵ and R²⁶ each represents an alkyl group, a fluorinated hydrocarbon group, an aromatic group, an alkoxy group, an aryloxy group, an alkylthio group, or an arylthio group; m2, n2, and p2 each represents an integer of 0-4; and X is the same as defined for X in Formula (1).

11. The resist composition of claim 10,
wherein the sulfonium salt represented by Formula (2) is further represented by Formula (3): 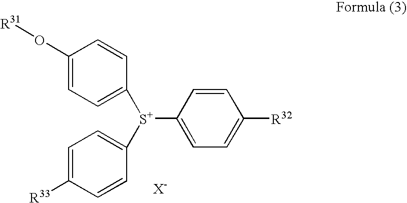
wherein R³¹ represents an alkyl group having 1-10 carbon atoms; R³² and R³³ each represents an alkyl group having 1-10 carbon atoms or an alkoxy group having 1-10 carbon atoms; and X is the same as defined for X in Formula (1).

12. The resist composition of claim 10,
wherein the sulfonium salt represented by Formula (2) is further represented by Formula (4): 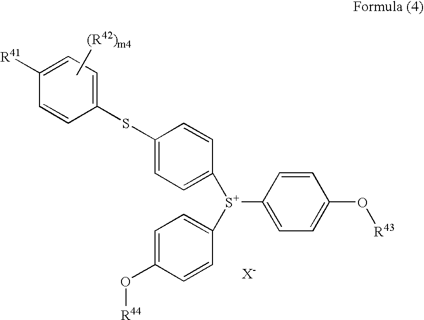
wherein R⁴¹ represents a hydrogen atom or an alkyl group having 1-10 carbon atoms; R⁴² represents a substituent; m4 represents an integer of 0-4; R⁴³ and R⁴⁴ each represents an alkyl group having 1-10 carbon atoms; and X is the same as defined for X of Formula (1).

13. The resist composition of claim 10,
wherein the sulfonium salt represented by Formula (2) is further represented by Formula (5): 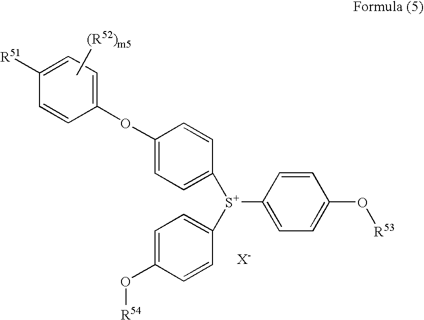
wherein R⁵¹ represents a hydrogen atom or an alkyl group having 1-10 carbon atoms; R⁵² represents a substituent; m5 represents an integer of 0-4; R⁵³ and R⁵⁴ each represents an alkyl group having 1-10 carbon atoms; and X is the same as defined for X of Formula (1).
